(19) United States
(12) Patent Application Publication
(10) Pub. No.: US 2014/0278726 A1
(43) Pub. Date: Sep. 18, 2014

(54) SYSTEMS AND METHODS FOR MANAGING WORKFLOW

(71) Applicants: John Poole, Beaverton, OR (US); Sanjiv Kochhar, Portland, OR (US); Kevin Huls, Sioux Falls, SD (US); Tonya Triebwasser, Sioux Falls, SD (US); Soila Santos, Beaverton, OR (US)

(72) Inventors: John Poole, Beaverton, OR (US); Sanjiv Kochhar, Portland, OR (US); Kevin Huls, Sioux Falls, SD (US); Tonya Triebwasser, Sioux Falls, SD (US); Soila Santos, Beaverton, OR (US)

(73) Assignee: Capitol One Financial Corporation, McLean, VA (US)

(21) Appl. No.: 14/209,175

(22) Filed: Mar. 13, 2014

Related U.S. Application Data
(60) Provisional application No. 61/784,333, filed on Mar. 14, 2013.

(51) Int. Cl. G06Q 10/06

(52) U.S. Cl. CPC G06Q 10/0633
USPC 705/7.27

(57) ABSTRACT

The disclosed embodiments provide systems, methods, and articles of manufacture for managing workflow. Consistent with disclosed embodiments, a method may include receiving a communication from a customer, the communication being associated with a financial service account of the customer. The method may also include determining one or more document types associated with the communication, and comparing the one or more document types to at least one priority level hierarchy. Additionally, the method may include determining a document identification number for the communication based on the comparison, assigning the document identification number to at least one queue based on the document identification number, and providing access to a document associated with the communication to a first agent on a request for one or more document identification numbers from the queue. One or more second agents may additionally be denied access.

### CROSS-REFERENCE TO RELATED APPLICATIONS

This application claims priority under 35 U.S.C. §119 to U.S. Provisional Application No. 61/784,333, filed on Mar. 14, 2013, which is expressly incorporated herein by reference in its entirety.

### BACKGROUND

Traditional workflow systems for tasks initiated by customer interactions often receive massive amounts of correspondences from customers. For example, over time a large number of customers may contact the customer service department of a company to report fraud, lodge complaints, make requests, ask questions, provide suggestions, etc. Typically, agents of the company are assigned to work on each task generated by the customer, i.e., to process and respond to the complaint or request. In traditional systems, each correspondence may be stored according to the type of correspondence. For example, correspondence relating to bankruptcy may be stored or otherwise associated together, and correspondences relating to fraud may be stored or otherwise associated with each other separately from the bankruptcy correspondence. Correspondence relating to both fraud and bankruptcy may thus have two associations.

Agents tasked with responding to customer correspondence, however, may be only be authorized to access one type of correspondence, leading to duplication, inefficiency, and customer dissatisfaction with customer service. For example, a first agent may have access to only fraud tasks and a second agent may have access to only bankruptcy tasks. This may prevent coordination between the agents at least because information associated with each respective task—or even knowledge that a related task exists—is not available to the other. Thus, relevant changes made to the fraud task may not be reflected in the bankruptcy task. Therefore, for example, the second agent may process the bankruptcy task without knowledge that the first agent has already started work on the related fraud task, which may also serve to resolve the bankruptcy task. Additionally, the disconnect between related tasks also leads to difficulty in monitoring the status of tasks. Shared access to related tasks, on the other hand, assists in the prevention of agents, for example, hiding or otherwise delaying the processing of a duplicated task assigned to them.

Accordingly, companies will benefit from improved monitoring and workflow regulation between its agents tasked with responding to customers.

### SUMMARY

Consistent with disclosed embodiments, systems and methods are provided for managing workflow. For example, the disclosed embodiments may allow a financial service provider, or other type of entity, to share information between multiple agents regardless of the task type or location of the agents in order to facilitate efficient workflow amongst the agents. In some embodiments, the financial service provider may receive correspondence from a customer requesting the financial service provider to take an action. For example, a customer may dispute charges on the customer's account and request the charges be removed. An agent, associated with the financial service provider, may receive the correspondence on a queue system, such that the first correspondence received is the first to be processed. Once the agent accesses the correspondence and begins processing it, other agents may become prevented from accessing and/or processing the correspondence. This may ensure, among other things, that only one agent may process a queued task at a time. Additionally, the queue system may allow the financial service provider to monitor the tasks being processed and prevent agents from delaying the processing of undesirable tasks.

The disclosed embodiments may include a file database storing the correspondence document and a workflow application database storing a document identification number associated with each correspondence document. The document identification number may be based on the document type (e.g., fraud, bankruptcy, etc.), and may be presented to the agent on the queue. The file database and workflow application database may be in communication such that an agent may receive the document identification number from the workflow application database and access the document in the file database.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1A illustrates an exemplary system for managing workflow consistent with disclosed embodiments.

FIG. 1B illustrates an exemplary system for managing workflow consistent with disclosed embodiments.

FIG. 2 illustrates another exemplary system for managing workflow consistent with disclosed embodiments.

FIG. 3 depicts a flowchart of an exemplary workflow management process consistent with disclosed embodiments.

FIG. 4 depicts a flowchart of an exemplary correspondence document receiving process consistent with disclosed embodiments.

FIG. 5 depicts a flowchart of an exemplary document identifier assignment process consistent with disclosed embodiments.

FIG. 6 depicts a flowchart of an exemplary document type rank determination process consistent with disclosed embodiments.

FIG. 7 depicts a flowchart of an exemplary document access process consistent with disclosed embodiments.

FIG. 8 depicts a flowchart of an exemplary provide report process consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

FIG. 1A is a diagram illustrating an exemplary system 100 for performing one or more operations consistent with the disclosed embodiments. In one embodiment, system 100 may include a network 110, a financial service provider 120, a client 130, a customer 140, an agent system 150, and an agent 160. The components and arrangement of the components included in system 100 may vary. Thus, system 100 may further include other components that perform or assist in the performance of one or more processes consistent with the disclosed embodiments.

Components of system 100 may be computing systems configured to provide a workflow management service consistent with disclosed embodiments. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 may be configured to communicate with one or more other components of system 100, including financial service provider 120 (including server 111), client 130, customer 140, agent system 150, and agent 160. In certain aspects, users may operate one or more components of system 100 to initiate one or more operations consistent with the disclosed embodiments. In some aspects, the one or more users may be employees of, or associated with, the entity corresponding to the respective component(s) (e.g., someone authorized to use the underlying computing systems or otherwise act on behalf of the entity). In other aspects, the user may not be an employee or otherwise associated with underlying entity. In still other aspects, the user may itself be the entity associated with the respective component (e.g., customer 140 operating client 130).

Network 110 may be any type of network configured to provide communications between components of system 100. For example, network 110 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary links between financial service provider 120 (e.g., server 111) and client 130 and financial service provider 120 and agent system 160.

Financial service provider 120 may be an entity that provides financial services. For example, financial service provider 120 may be a bank, credit card issuer, or other type of financial service entity that generates, provides, manages, and/or maintains financial service accounts for one or more users. Financial service accounts may include, for example, credit card accounts, checking accounts, savings accounts, reward accounts, and any other types of financial service account known to those skilled in the art. Financial service provider 110 may include infrastructure and components that are configured to generate and provide financial service accounts and financial service account products (e.g., credit cards, check cards, etc.). Financial service provider 120 may include a server 111 configured to execute software instructions stored in one or more memory devices to perform one or more operations consistent with the disclosed embodiments, as discussed in more detail below.

Client 130 may be one or more computing devices that are configured to execute software instructions for performing one or more operations consistent with the disclosed embodiments. Client 130 may be a desktop computer, a laptop, a server, a mobile device (e.g., tablet, smart phone, etc.), and/or any other type of computing device. Client 130 may include one or more processors configured to execute software instructions stored in memory, such as memory included in client 130. Client 130 may include software that when executed by a processor performs known Internet-related communication and content display processes. For instance, client 130 may execute browser software that generates and displays interfaces including content on a display device included in, or connected to, client 130. The disclosed embodiments are not limited to any particular configuration of client 130. For instance, client 130 may be a mobile device that stores and executes mobile applications that provide email, text, or messaging correspondences to financial service provider 110. In other embodiments, client 130 may be configured to send faxes or document hardcopies to financial service provider 110.

In some embodiments, a customer 140 may use client 130 to perform one or more operations consistent with the disclosed embodiments. In one aspect, customer 140 may be one or more customers of financial service provider 120. For instance, financial service provider 120 may maintain a financial service account (e.g., credit card account) for customer 140 that customer 140 may use to purchase goods and/or services online or at brick and mortar locations associated with a merchant. In other embodiments, customer 140 may be a potential customer of financial service provider 110, a previous customer of financial service provider 110, or may not be affiliated with financial service provider 110 from the user's perspective and/or the financial service provider 110's perspective. In one aspect, customer 140 may prepare and send communications to financial service provider 120 that generates workflow handled by agent system 150. The communication may be sent via, for example, client 130 and may include data related to or otherwise associated with financial service accounts of the user provided by financial service provider 120. In other embodiments, customer 140 may send physical copies of the communication to financial service provider 120, for example, through a postal service. In still other embodiments, customer 140 may communicate with components of system 100 via other devices such as, for example, a touch-tone telephone.

Agent system 150 may include an entity associated with receiving and processing task requests. For example, in some embodiments, agent system 150 may include a customer service center, a customer call center, etc. In some embodiments, as shown in FIG. 1A, agent system 150 may be a separate entity. In other embodiments, as shown in FIG. 1B, agent system 150 may be included in financial service provider system 120 and configured to provide services in a manner consistent with that disclosed above in connection with agent system 150 shown in FIG. 1A. Consistent with disclosed embodiments, agent system 150 may use or otherwise directly communicate with computing devices of financial service provider 120 (e.g., server 111). Furthermore, agent system 150 may directly access memory devices of financial service provider 120 (not shown) to retrieve, for example, data associated with a customer of financial service provider 120 and/or a customer communication(s). Components depicted in FIG. 1B may otherwise be configured and operate similar to similarly labeled components disclosed above in connection with FIG. 1A. In still other embodiments, agent system 150 may be diversely located such that, for example, aspects or components of agents system 150 may be included in financial service provider 120 while other aspects or components are separate from financial service provider 120. Agent system 150 may include one or more agents 160. In some embodiments, agent 160 may use agent system 150 to perform one or more operations consistent with disclosed embodiments. For example, agent 160 may use agent system 150 to process correspondences from customer 140 and received by financial service provider 120. Agent 160 may have access to financial service accounts, associated with customer 140 and financial service provider 120, through server 111. Agent 160 may include, for example, one or more employees of an entity associated with agent system 150, including managers and agents that report to the managers.

It is to be understood that the configuration and boundaries of the functional building blocks of system 100 has been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Furthermore, although financial service provider 120 and server 111 may be used to describe particular implementations of disclosed embodiments, such embodiments (or parts thereof) may also (or alternatively) be implemented using other components of system 100, multiple components of system 100 (i.e., a distributed system), and/or suitable components not depicted. Such alternatives fall within the scope and spirit of the disclosed embodiments.

FIG. 2 shows an exemplary system 200 for implementing embodiments consistent with the present disclosure. Variations of exemplary system 200 may be used by financial service provider system 110, client 130, agent system 150, and/or other components of system 100. For example, system 200 may be server 111 of financial service provider 110. In one embodiment, system 200 may include a server 211 having one or more processors 221, one or more memories 223, and one or more input/output (I/O) devices 222. Alternatively, server 211 may take the form of a mobile computing device, general purpose computer, a mainframe computer, or any combination of these components. According to some embodiments, server 211 may comprise web server(s) or similar computing devices that generate, maintain, and provide web site(s) consistent with disclosed embodiments. Server 311 may be standalone, or it may be part of a subsystem, which may be part of a larger system. For example, server 211 may represent distributed servers that are remotely located and communicate over a network (e.g., network 110) or a dedicated network, such as a LAN.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 211.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider system 120, client 130, agent system 150, and/or other components of system 100, may, via server 211, access one or more remote programs that, when executed, perform functions related to certain disclosed embodiments. Memory 223 may also store data 225 that may reflect any type of information in any format that the system may use to perform operations consistent with the disclosed embodiments.

I/O devices 222 may be one or more devices configured to allow data to be received and/or transmitted by server 211. I/O devices 222 may include one or more digital and/or analog communication devices that allow server 211 to communicate with other machines and devices, such as other components of systems 100.

Server 211 may also be communicatively connected to one or more database(s), such as file database 227 and/or workflow application database 228. Server 211 may be communicatively connected to database(s) 227, 228 through network 150. Databases 227, 228 may include one or more memory devices that store information and are accessed and/or managed through server 211. By way of example, database(s) 227, 228 may include Oracle™ databases, Sybase™ databases, or other relational databases or non-relational databases, such as Hadoop sequence files, HBase, or Cassandra. The databases or other stores may include, for example, data and information related to the source and destination of a network request, the data contained in the request, etc. In some embodiments, file database 227 may store data associated with correspondence received from client 130. For example, file database 227 may store data associated with a particular request from a customer including, for example, the date received, the topic, document type, text from the request, customer contact information, customer account information, etc. In some embodiments, workflow application database 228 may store a document identification number associated with each correspondence. For example, a set of numbers or symbols associated with a particular correspondence. Systems and methods of disclosed embodiments, however, are not limited to separate databases. In one aspect, system 200 may include databases 227, 228, as shown. Alternatively, one or more of databases 227, 228 may be located remotely from the system 200. Database 227, 228 may include computing components (e.g., database management system, database server, etc.) configured to receive and process requests for data stored in memory devices of database(s) 227, 228 and to provide data from databases 227, 228.

FIG. 3 is a flow diagram 300 of an exemplary process for managing workflow, consistent with disclosed embodiments. In one aspect, in step 310, financial service provider 120 may receive a document (i.e., a communication including user data, identification information, text, an image, and/or any other data suitable for use by agency system 150) from customer 140 (e.g., via client 130). The document may be stored within a database associated with financial service provider 110 and/or agent system 150 (e.g., file database(s) 227). In some embodiments, server 111 may (if required) scan the received document, form an image of the document, and/or otherwise process the document for subsequent use by, for example, agency system 150.

Server 111 may additionally assign a document identifier to each document (e.g., related to fraud procedures, banking, credit counseling services, etc.). For example, if server 111 identifies only one applicable document type (step 315; No), server 111 may assign a document identification number corresponding to that document type (step 325). Therefore, all fraud type documents may receive a document identification number indicative of fraud type documents, all banking type documents may receive a document identification number indicative of banking type documents, etc. The document identification numbers may each be stored by server 111 in, for example, workflow application database 228. It is further contemplated that, according to some embodiments, agent system 150 will have equal access to file database 227 and workflow application database 228. Therefore, agent 160 assigned to a correspondence, may be able to access (e.g., via agent system 150) the document identification number associated with the correspondence in the workflow application database and the underlying document in the file database.

If sever 111 determines multiple document types are potentially applicable to the received correspondence document (step 315; Yes), server 111 may, in one embodiment, rank the document types applicable to the document and assign the associated document identification numbers based on the ranking (step 320). For example, server 111 may receive a document relating to at least two different document types (e.g., “banking” and “fraud”). Server 111 may compare each applicable document type according to a hierarchy of document types and assign a document identification number corresponding to the highest applicable document type ranking. The hierarchy of document types may be determined, for example, by one or more of agent(s) 160 and/or financial service provider 120. Server 111 may assign a document identification number according to the highest applicable document type ranking (step 325) and store the document (e.g., in workflow application database 228) (step 330). For example, if fraud has a higher priority level than banking, a document relating to both fraud and banking may only receive a document identification number associated with fraud type documents. Further, server 111 may store the correspondence in workflow application database 228 based on this document identification number. According to some embodiments, the document identification numbers may be stored in a queue system such that, for example, all fraud type documents are accessible to agent 160 (via, e.g., agent system 150) on a first queue and all banking type documents are stored in a second queue.

Server 111 may additionally provide agent(s) 160 access to the documents (step 340) so that agent 160 may process the document (i.e., investigate a customer complaint, respond to the customer communication, etc.). According to some embodiments, server 111 may assign one or more queues dedicated to a document identification number or group of identification numbers and store the one or more queues in, for example, workflow application database 228. A designated agent (e.g., the next available agent) may be presented with the document identification number on top of the queue (e.g., the next correspondence to be processed). The designated agent may search file database 227 for the document associated with the document identification number (via, e.g., agent system 150 and/or server 111). In response to the search, server 111 may provide the appropriate document(s) to the designated agent so that the designated agent may begin processing the document. According to some embodiments, server 111 may block access to the document from other agents 160 (i.e., agents other than the designated agent) until, for example, the designated agent returns the document to server 111.

In step 350, according to some embodiments, server 111 may provide a report detailing agent interactions with documents stored in workflow database 228 over a predetermined time period (step 350). For example, the report may provide data showing the number and types of documents imported into, accessed, and/or deleted from the workflow database over the predetermined time period, the particular agent(s) that processed those documents, the disposition of any issue raised by the document, etc. FIG. 4 depicts a flow chart of an exemplary process 400 for receiving a correspondence document consistent with disclosed embodiments. In some embodiments, financial service provider 120 may receive a correspondence document from customer 140 (via, e.g., client 130, an interface provided at financial service provider 120, etc.), as shown in step 410. A correspondence document may include, for example, a request, a complaint, a question from customer 140, or the like, and may be received via electronic communication or paper correspondence. The correspondence document may be, for example, sent through client 130 and received by server 111. In one example, a correspondence document may include a question regarding fraud protection or a complaint regarding a checking interest rate.

Sever 111 may process the received document for subsequent use by, for example, agency system 150 (step 420). For example, server 111 may, if required, scan each received document, prepare an image of each document, extract relevant data from the image using techniques known to those of skill in the art, and/or format the data associated with the received document according in a format suitable for storage in, for example, workflow application database 228. For example, paper correspondence may be scanned and processed by server 111 prior to storing the correspondence document. In another example, sever 111 may process a telephone transcript of a customer service call by employing data extraction techniques known to those of skill in the art to extract relevant data from the transcript. In other embodiments, server 111 may receive the correspondence as electronic communications (e.g., via e-mail, a web interface provided by financial service provider 120 and/or agent system 150, etc.). According to some embodiments, documents received by electronic communication may be received in a format suitable for storage in file database(s) 227 and such that the documents may be stored directly into database(s) 227 without substantial processing. Server 111 may then store the documents in a database, for example, in a system employing FileNet® (step 430). The file database may be an internal component of server 111 or may form a separate and distinct database. In one embodiment, the file database may include file database 227.

Additionally, upon receiving a correspondence from customer 140, server 111 may provide responsive correspondence to customer 140 (step 440). This responsive correspondence may include, for example, a letter, e-mail, SMS message, or the like indicating that financial service provider 110 and/or agent system 150 has received the user's correspondence and is investigating the request, complaint, question, etc. Server 111 may send the responsive correspondence to, for example, client 130.

FIG. 5 depicts a flowchart of an exemplary process 500 for assigning document identifiers. As shown in step 510, server 111 may determine a document type associated with each document. For example, server 111 may determine to which business section (e.g., fraud, banking, deceased accounts, credit counseling, etc.) the correspondence received from customer 140 most closely relates based on, for example, key words, phrases, symbols, pictures, etc. identified in the correspondence document. Server 111 may identify key words, phrases, symbols, pictures, etc. based on stored information (see, e.g., step 430) associated with the correspondence document. For example, server 111 may recognize the word “fraudulent” and determine that the correspondence document is a fraud document type. In another embodiment, server 111 may recognize the phrase “I have charges on my account I did not make” and determine that the correspondence document is a fraud document type. It is contemplated that server 111 may be required to recognize a threshold number of key words, phrases, symbols, or pictures in order to determine the document type. In one example, server 111 may be required to recognize three words associated with a particular business section/document type to determine the document type. Additionally or alternatively, server 111 may determine the document type based on the source of the document. For example, in one embodiment, server 111 may determine a correspondence to be a fraud type document if received, for example, by a fraud portion of a website associated with financial service provider 120, a fraud specific mailbox, e-mail address, or a fax number associated with financial service provider 120. In other embodiments, server 111 may determine a correspondence document to be a banking type document if received by a banking division of financial service provider 120.

Server 111 may assign a unique or substantially unique document identification number to each document based on the document type (step 520). For example, all documents of a document type may share a particular combination of numbers that form a part of the document identification number. In one embodiment, all fraud documents may be a assigned document identification number beginning with “01” such that server 111 may assign a first fraudulent document a document identification number of “01-0001” and a second fraudulent document a document identification number of “01-0002”. Additionally or alternatively, the document identification number may indicate how the document was received (i.e., by mail, e-mail, website interface, fax, instant message, etc.). It is further contemplated that each document identification number may include various numbers, letters, symbols, etc. in various configurations and formats.

Server 111 may store the document identification numbers in a database, such as workflow application database 228 (step 530). The workflow application database may be an internal component of server 111 or may form a separate and distinct database. In some embodiments, the workflow application database may be in communication with the file database such that information may be shared between the two databases. The document identification numbers may be stored in the workflow application database in one or more queues. In some embodiments, server 111 may assign the document identification numbers to a queue based on the document type. For example, all document identification numbers associated with fraud type documents may be stored in a first queue, all document identification numbers associated with banking type documents may be stored in a second queue, etc.

FIG. 6 depicts a flowchart of an exemplary process 600 to assign document identifiers based on one or more document type rankings. In step 610, a server 111 may determine priority levels for each document type based on, for example, criteria and/or rules specified by an agent 160 of financial service provider 120 (see, e.g., step 330). In one embodiment, server 111 may assign fraud a higher priority level than banking based on specified criteria and/or rules. Therefore, if server 111 receives a correspondence document that it determines may be classified as both fraud and banking types, server 111 may assign the correspondence as a “fraud” type document based on the predetermined priority levels (step 620). At step 630, server 111 may assign a document identification number to the correspondence and store the correspondence in a database (e.g., workflow application database 228) based on the assignment (step 630). In the example above, server 111 may assign the correspondence a document identification number associated with a fraud type document. The document identification number may be associated with a queue in the workflow application database that is associated with fraud type documents.

In other embodiments, server 111 may determine two or more document types to be of the same priority level. Therefore, server 111 may assign correspondences corresponding to these document types two or more document identification numbers. For example, server 111 may determine fraud and banking to be of the same priority level. A correspondence classified as both fraud and banking may be assigned a first document identification number associated with fraud type documents and a second document identification number associated with banking type documents. In other embodiments, a single document identification number may be assigned that includes a combination of numbers indicating the two or more applicable document types (e.g., fraud and banking). Using the exemplary number scheme of step 520, for example, all documents that may be classified as a fraud and banking document may be assigned identification numbers beginning with “11” such that server 111 may assign such a document the document identification number of “11-0001.”

Server 111 may, in some embodiments, provide agent 160 with the ability to change the priority levels (step 640). For example, server 111 may allow agent 160 to identify credit counseling as a higher priority level than banking, lower than fraud, etc. Server 111 may provide this ability to all agents of agent 160 or only a selected number of agents such as, for example, managers. In other embodiments, server 111 may provide the ability of other entities and components of system 100 to change the priority levels.

Server 111 may additionally provide agent 160 access to the document stored in the file database and the document identification number stored in the workflow application database. This may allow agent 160 to process the correspondence (i.e., review the correspondence, investigate any tasks initiated by the correspondence, respond to the customer, etc.). FIG. 7 depicts a flowchart of an exemplary process 700 to provide agent access to documents. Server 111, as shown in step 710, may provide a document identification number to a designated agent in response to, for example, a request of agent 160 for the next document in the queue. The document identification number may be provided through email, text, or any suitable form of communication. Additionally or alternatively, the document identification number may be provided to the designated agent (e.g. the next available agent 160) by allowing agent 160 to access a file system, interface, or webpage displaying the document identification number. In one embodiment, the document identification numbers are stored in one or more queues, and server 111 may provide access of the one or more queues to agent 160. Server 111 may store all documents corresponding to particular document types in different queues. For example, all document identification numbers corresponding to fraud may be stored in a first queue and all document identification numbers corresponding to banking may be stored in a second queue. Server 111 may provide access for agent 160 to all queues, a subset of queues, or a predetermined number of queues. In one example, agent 160 may be assigned to only queues associated with fraud type documents.

Server 111 may provide the document identification numbers to agent 160 on the queues as a first-in-first-out system. Therefore, document identification numbers may be presented to agent 160 in the order the corresponding documents were received by financial service provider 120 and/or agent system 150. In one embodiment, a manager or other agent 160 may change the order of the queue and assign documents to various agents 160. Additionally, server 111 may provide the ability for agent 160, agent system 150, or another entity, to return an accessed document back to the queue. For example, server 111 may provide a designated agent for a first document, whose access blocks other agents' access, to release the first document back to the top of the queue.

Server 111 may search the file database to locate the document associated with the document identification number (step 720) based on, for example, a request provided by designated agent using the document identification number. Server 111 may additionally retrieve the document from the file database and provide the document to designated agent, allowing designated agent (step 730) to review, analyze, and respond to a request in the document. In some embodiments, server 111 may provide access of the document to designated agent through a website, web portal, mobile device application, etc.

It is further contemplated that server 111 may block other agents 160 other than the designated agent from accessing a document while the designated agent retains access to the document (step 740). This may prevent two agents 160 from working on the same correspondence. Additionally, server 111 may block access to agents 160 when the agents 160 are, for example, out of office, on vacation, or no longer employed with the financial service provider 120. Additionally, server 111 may block access to agents 160 when the agents 160 change roles within financial service provider 120. This may prevent a first agent 160 from blocking access of a document to a second agent 160 while the first agent is, for example, out of the office. Server 111 may provide the ability for agent 160 to determine when an agent 160 is out of office, on vacation, no longer employed, or in another role.

In other embodiments, server 111 may only provide the document to the designated agent and not the document identification number. Therefore, the designated agent may receive the document on a queue, for example, without knowledge of the document identification number.

As shown in FIG. 8, server 111 may provide a report reflecting the managing of workflow. For example, the report may provide a high level overview of the workflow for a particular time period in a format useful to one or more managers of agents 160 of agent system 150. According to some embodiments, the report may include: the average number of documents added to a queue, the average number of documents processed, what agents worked on which documents, how many documents have been started, how may documents each agent returned to a queue, the average time a document was on the queue before processing started, etc.

In some embodiments, server 111 may determine a time period (days, week, month, year, etc.) for the report to cover (step 810) based on, for example, one or more time periods specified in a query requesting the report. In other embodiments, reports may be generated regularly with each report covering the time period since the prior regular report. In other embodiments, the time period may include two or more nonconsecutive time segments based on, for example, date ranges included in a query requesting the report.

Server 111 may access stored data associated with customer correspondence over the relevant time period (step 820). For example, server 111 may access the data for the relevant time period to determine the number of documents added to a queue, the number of documents processed, what agents worked on which documents, how many documents have been started during the time period, how many documents each agent 120 returned to a queue, the average time a document was on the queue before processing started, etc. during the relevant time period. As shown in step 830, server 111 may provide a report showing the data in a user-friendly format.

Other embodiments will be apparent to those skilled in the art from consideration of the specification and practice of the disclosed embodiments disclosed herein. For example, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples. Thus, it is intended that the specification and examples be considered as exemplary only, with a true scope and spirit of the disclosed embodiments being indicated by the following claims.

What is claimed is:

1. A system for managing workflow, comprising:
one or more memory devices storing instructions; and
one or more processors configured to execute the instructions to:
receive a communication from a customer, the communication being associated with an account of the customer;
determine one or more document types associated with the communication;
compare the one or more document types to at least one priority level hierarchy;
determine a document identification number for the communication based on the comparison;
assign the document identification number to at least one queue based on the document identification number; and
provide access to a document associated with the communication in response to a request for one or more document identification numbers from the at least one queue.

2. The system of claim 1, wherein the one or more processors are further configured to:
provide access to the document to a first agent; and
deny access to the document to a second agent.

3. The system of claim 1, wherein the one or more processors are further configured to:
store the communication in the document in a file database, wherein the file database is communicatively connected to the workflow application database.

4. The system of claim 1, wherein the one or more processors are further configured to execute the instructions to:
provide a responsive communication to the customer indicating the communication has been received.

5. The system of claim 1, wherein the document identification number is associated with more than one document type.

6. The system of claim 1, wherein the workflow application database includes the at least one queue and each queue is associated with a different document type.

7. The system of claim 1, wherein the one or more processors are further configured to execute the instructions to:
allow the first agent to change the one or more priority levels.

8. The system of claim 1, wherein the one or more processors are further configured to execute the instructions to:
allow the first agent to return a document to the at least one queue.

9. The system of claim 1, wherein the one or more processors are further configured to execute the instructions to:
determine a plurality of document types associated with the document are of equal priority based on the comparison; and
assign a plurality of document identification numbers based on the determination.

10. The system of claim 1, wherein the one or more processors are further configured to execute the instructions to:
determine a plurality of document types associated with the document are of equal priority based on the comparison; and
assign a single document identification number indicative of multiple document types based on the determination.

11. The system of claim 1, wherein the one or more processors are further configured to execute the instructions to perform:
provide a report including workflow data generated over a predetermined time period.

12. The system of claim 11, wherein the workflow data includes one or more of a number of documents accessed, types of documents accessed, a number of documents deleted, types of documents deleted, indication of the specific agents that have accessed particular documents, and disposition of issues raised in documents.

13. A method for managing workflow, comprising:
receiving a communication from a customer, the communication being associated with a financial service account of the customer;
storing the communication as a document in a workflow application database;
determining one or more document types associated with the document, wherein each document type has one or more priority levels;
comparing the one or more document types to at least one priority level hierarchy;
determining a document identification number for the document based on the comparison;
assigning the document identification number to at least one queue based on the document identification number;
providing access to the document to a first agent; and
denying access to the document to one or more second agents.

147. The method of claim 13, wherein the document identification number is associated with more than one document type.

15. The method of claim 13, wherein the workflow application database includes one or more queues and each queue is associated with a different document type.

16. The method of claim 13, further including allowing the first agent to change the one or more priority levels.

17. The method of claim 13, further including:
determining that a plurality of document types associated with the communication are of equal priority based on the comparison; and
assigning a plurality of document identification numbers based on the determination.

18. The method of claim 13, further including:
determining that a plurality of document types associated with the communication are of equal priority based on the comparison; and
assigning a single document identification number indicative of multiple document types based on the determination.

19. The method of claim 13, wherein the workflow data includes one or more of a number of documents accessed, types of documents accessed, a number of documents deleted, types of documents deleted, indication of the specific agents that have accessed particular documents, and disposition of issues raised in documents.

20. A non-transitory computer-readable medium having stored thereon executable instructions that, when executed by a processor, cause the processor to perform operations comprising:
determining one or more document types associated with a document;
comparing the one or more document types to at least one priority level hierarchy;
determining a document identification number for the document based on the comparison;
assigning the document identification number to at least one queue based on the document identification number;
providing access to the document to a first agent; and
denying access to the document to one or more second agents.
